(19) United States
(12) Patent Application Publication
(10) Pub. No.: US 2026/0178911 A1
(43) Pub. Date: Jun. 25, 2026

(54) FULLY BINARY NEURAL NETWORK AND RELATED SYSTEMS AND METHODS

(71) Applicant: Datalogic IP Tech, S.r.l., Bologna (IT)

(72) Inventor: Lorenzo Vorabbi, Rimini (RN) (IT)

(21) Appl. No.: 18/989,580

(22) Filed: Dec. 20, 2024

(51) Int. Cl. G06N 3/084

(52) U.S. Cl. CPC G06N 3/084

(57) ABSTRACT

A binary neural network (BNN) without floating-point layers uses inter-layer input data and inter-layer output data represented in n-bit binary format, where n is less than 32. For instance, n may be 8. Each layer of a set of hidden layers is operative to perform binarized operations on respective input data and at least one of the hidden layers, and includes a trained one-bit binary quantizer with a preconfigured binarization threshold that was configured during training.

### TECHNICAL FIELD

The present disclosure generally relates to machine learning and, more particularly, to binary neural networks (BNNs).

### BACKGROUND

Binary Neural Networks (BNNs) have emerged as a powerful solution for high-speed processing and low power consumption across various technological domains. Their streamlined architecture renders them particularly suitable for a multitude of applications, especially within the realms of embedded systems and edge computing.

In the fast-evolving world of mobile and edge devices, such as smartphones, tablets, and other portable gadgets, BNNs shine due to their minimal power needs and compact memory footprint. This makes them advantageous for tasks that require real-time processing like image and speech recognition, significantly enhancing the capabilities of these devices without imposing heavy compute or battery usage. Embedded systems, a critical component of IoT devices, automotive electronics, and wearable technology, also greatly benefit from the efficiency of BNNs. These systems, often operating under strict power and cost constraints, can leverage BNNs to perform real-time processing tasks without requiring expensive and power-intensive processing circuitry. Similarly, in the manufacturing, industrial automation, and logistics sector, BNNs are often employed to enable real-time monitoring and control systems. This capability significantly boosts operational efficiency and reduces costs. Other applications of BNNs include real-time image processing, encompassing facial recognition, object detection, and gesture recognition, particularly in smartphones, security cameras, and symbol readers, as well as augmented Reality (AR) applications, which require real-time image and environment processing, and advanced driver-assistance systems (ADAS) and autonomous vehicles, which leverage BNNs for real-time decision-making processes like object detection and collision avoidance.

Overall, the primary advantage of BNNs in these diverse applications is their ability to handle complex computational tasks with significantly reduced power and memory requirements. A BNN can significantly accelerate the inference time of the network replacing the multiply-and-accumulate operation with a bit-wise (XNOR) operation that uses 1-bit activations and weights, typically −1 or +1. Using 1-bit data not only can save the expensive model's storage, but also eliminates the need for multiply-and-accumulate operations resulting more friendly for field-programmable gate array (FPGA) and single-instruction multiple-data (SIMD) processing.

One drawback of this approach is that it leads to significant reduction in the representational capacity compared to floating-point networks. This can result in a loss of accuracy, especially in complex tasks that require fine-grained feature discrimination. Another challenge is the integration of binary layers with floating-point layers. While binary layers offer computational efficiency, they might not be sufficient for certain tasks that require higher precision. In such cases, floating-point layers are used alongside binary layers, but this integration can be complex. The transition between binary and floating-point representations involves careful management to ensure that the network remains efficient while still capturing the necessary detail.

Moreover, training BNNs with floating-point layers also poses difficulties. The gradient-based optimization methods commonly used in deep learning are less effective due to the discrete nature of binary weights. Techniques like the straight-through estimator (STE) are employed to approximate gradients, but these can lead to suboptimal training dynamics.

Various open-source frameworks are available to design, train and deploy BNNs. For instance, Larq is based on Tensorflow, and Plumerai provides a custom and highly optimized implementation using inline assembly code of binary convolution that can be easily deployed within Tensorflow Lite. Alternatively, Bolt and DaBNN inference engines are completely custom and do not rely on a well-established framework such as PyTorch or Tensorflow.

Despite these, and other, available frameworks which offer code libraries with optimized binary operations, they still rely on floating-point computations before and after each binary layer. Moreover, inside a BNN, the first and last layers are usually kept in floating point because their binarization would lead to a substantial accuracy drop. The conversion overhead from floating point-to-binary and binary-to-floating point introduces extra compute overhead when the model is deployed on edge devices, consequently reducing efficiency in its implementation.

A practical solution is needed to address these, and other, challenges in the design and deployment of BNNs.

### SUMMARY

Aspects of this disclosure are directed to a hybrid binary and n-bit quantized model of a BNN, which avoids floating-point operations. In some embodiments, n is 8; whereas other embodiments may quantize to more or fewer bits. Some implementations, which may be executed on embedded devices such as the ARM Cortex A53 processor, can achieve the same or similar accuracy as a floating-point/8-bit quantized model for various classification datasets (e.g., Hammingbird 1D finder pattern classification, Damatrix Elle Validation, NoRead Classification).

In some aspects, the techniques described herein relate to a system for implementing a binary neural network (BNN) on a computing device, the system including: processing hardware, including instruction processing, memory, and input/output circuitry, the memory including instructions that, when executed by the processing circuitry, cause the processing hardware to implement a first instance of a BNN model that includes: a plurality of layers including an input layer, an output layer, and a plurality of hidden layer groups, each hidden layer group including a downscaling operation layer, a batch normalization layer, and an activation layer; wherein the first instance of the BNN model is operative in an inference mode using preconfigured parameters from a training session performed on a second instance of the BNN model; wherein in the inference mode, each layer of the set of hidden layers receives inter-layer input data and produces inter-layer output data in a forward-propagating direction, wherein the inter-layer input data and the inter-layer output data are represented in n-bit binary format, wherein n is less than 32, and wherein each layer of the set of hidden layers is operative to perform binarized operations on respective input data and at least one of the hidden layers includes a trained one-bit binary quantizer with a configured binarization threshold; wherein the preconfigured parameters from the training session include weights, biases, and the binarization threshold.

In some aspects, the techniques described herein relate to an automated method for implementing a first instance of a binary neural network (BNN) model on a computing device, the method including: providing a plurality of layers including an input layer, an output layer, and a plurality of hidden layer groups, each hidden layer group including a downscaling operation layer, a batch normalization layer, and an activation layer; operating the first instance of the BNN model in an inference mode using preconfigured parameters from a training session performed on a second instance of the BNN model; wherein in the inference mode, by each layer of the set of hidden layers: receiving inter-layer input data; producing inter-layer output data in a forward-propagating direction, wherein the inter-layer input data and the inter-layer output data are represented in n-bit binary format, wherein n is less than 32, and performing binarized operations on respective input data; operating, by at least one of the hidden layers, a trained one-bit binary quantizer with a configured binarization threshold; and in the inference mode, applying the preconfigured parameters from the training session which include weights, biases, and the binarization threshold.

### BRIEF DESCRIPTION OF THE DRAWINGS

FIG. 1 is a simplified block diagram illustrating an example architecture of an inference path of a binary neural network (BNN) according to some embodiments.

FIGS. 2A-2B illustrate examples of a trainable binarization quantizer according to some embodiments.

FIG. 3 is a block diagram illustrating an example of an augmented switched-path convolution layer according to an embodiment.

FIG. 4 is a flow diagram illustrating an example process for training a BNN according to some embodiments.

FIG. 5 is a diagram illustrating an example of an activation function which is utilized according to some embodiments.

FIG. 6 illustrates an example structure of a portion of a BNN layer stack according to some embodiments.

FIG. 7 illustrates column-major format, compared against row-major format, for a batch size of 16.

FIGS. 8-12 illustrate a binarization process according to a related aspect of this disclosure in which a VSRI instruction is utilized efficiently according to an example.

FIG. 13 is a high-level block diagram illustrating an example system architecture of an edge device in which a BNN according to various embodiments as described above may be implemented.

FIG. 14 is a simplified block diagram illustrating a portion of processing hardware of the edge device of FIG. 13 according to one example.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

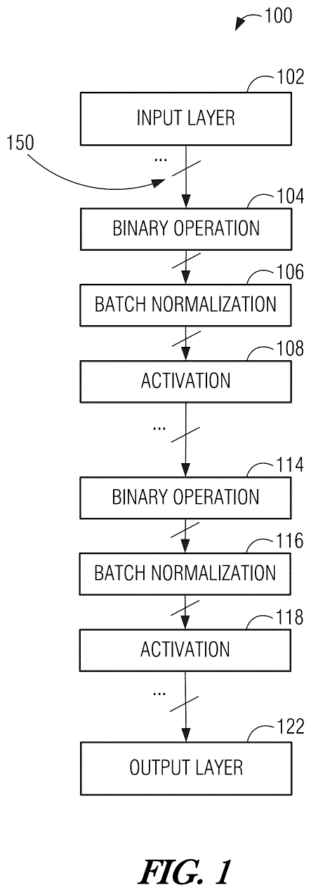

FIG. 1 is a simplified block diagram illustrating an example architecture of an inference path of a binary neural network (BNN) 100. BNN 100 includes input layer 102, output layer 122, and a set of hidden layers. The hidden layers in the example depicted include two groups, with the first group having binary operation layer 104, batch normalization layer 106, activation layer 108, among other layers which are not shown for simplicity. The second group includes binary operation layer 114, batch normalization layer 116, and activation layer 118, among others. In this simplified example, a sequential series of layers is shown; however, in other implementations, shortcuts, skipped connections or more complex schemes may be utilized. Additional binarized layers may be employed, such as binary max pooling, binary average pooling, or the like.

Notably, regardless of the topology of BNN 100, the inputs and outputs of hidden layers 104-118, indicated at 150, are n-bits wide. In some embodiments, n is less than 32. For instance, n may be 16, 8, or other suitable width.

Binary operation layer 104 and binary operation layer 114 each may be a binarized equivalent of an operational layer, such as a convolutional layer, or a fully-connected (dense) layer. Batch normalization layer normalization layer 106 and batch normalization layer 116 are binarized normalization layers that work to standardize the inputs to a layer for each mini-batch, using computation of mean and variance, normalizing, and scaling and shifting. Activation layer 108 and activation layer 118 are each a binarized activation layer of a suitable type. Examples include hyperbolic tangent (tanh), rectified linear unit (ReLU), leaky ReLu, double-leaky ReLU parametric ReLU, or the like.

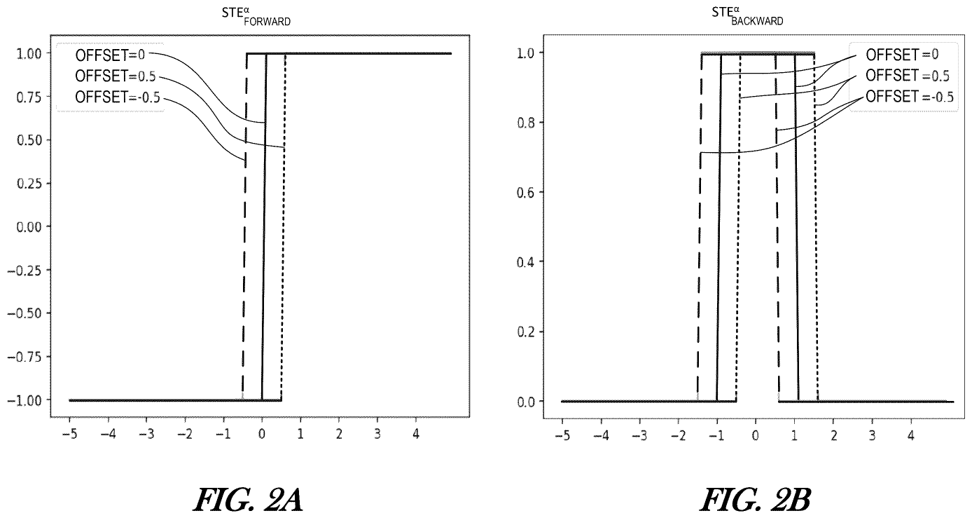

According to one aspect of the invention, one or more binary operational layers implements a trainable quantizer that converts n-bit input into a binary representation. In some embodiments, the trainable quantizer introduces a variable offset of the binarization threshold. FIGS. 2A-2B illustrate examples of a trainable binarization quantizer. FIG. 2A illustrates variable offsets applicable in the forward direction, whereas FIG. 2B illustrates variable offsets applicable in the backward direction (as used during backpropagation training). In these examples, the trainable quantizer implements a variation of a straight-through estimator (STE), which is referred to as STEa.

The forward-direction trainable quantizer with variable offset as illustrated in FIG. 2A may be expressed generally as follows:

$${STE}_{forward}^{α} = \{ \begin{matrix}+ 1 & if x + α \geq 0 \\ - 1 & otherwise\end{matrix}$$

where α is a configured offset of floating-point input x. As shown in FIG. 2A, a may have values of 0, 0.5, and −0.5.

The backward-direction trainable quantizer with variable offset as illustrated in FIG. 2B may be expressed generally as follows:

$${STE}_{backward}^{α} ( x ) = \{ \begin{matrix}1 & if - 1 + α \leq x \leq + 1 + α \\ 0 & otherwise\end{matrix}$$

where α is a configured offset of input x. As shown in FIG. 2B, α may have values of 0, 0.5, and −0.5. Variable offset a is a bias which is adjustable as part of the training process of the BNN, i.e., via backpropagation.

Another aspect of the invention is directed to binarization of downscaling layers. A downscaling layer is a layer in which the amount of information at the output is less than the amount of information at the input. For instance, a fully-connected layer that has fewer neurons than inputs achieves a downscaling operation. According to some embodiments, training of the BNN is performed using both, binary, and floating-point modes. To accommodate this training technique, each downscaling layer is augmented with a specialized switching function, which switches the input among two data paths based on whether the input is binary or floating point. One data path is for floating-point input data, and includes floating-point operations such as convolution, fully-connected (matrix multiplication), or the like. The other data path is for binary input data, and includes 1-bit quantization operations such as STE or STEα.

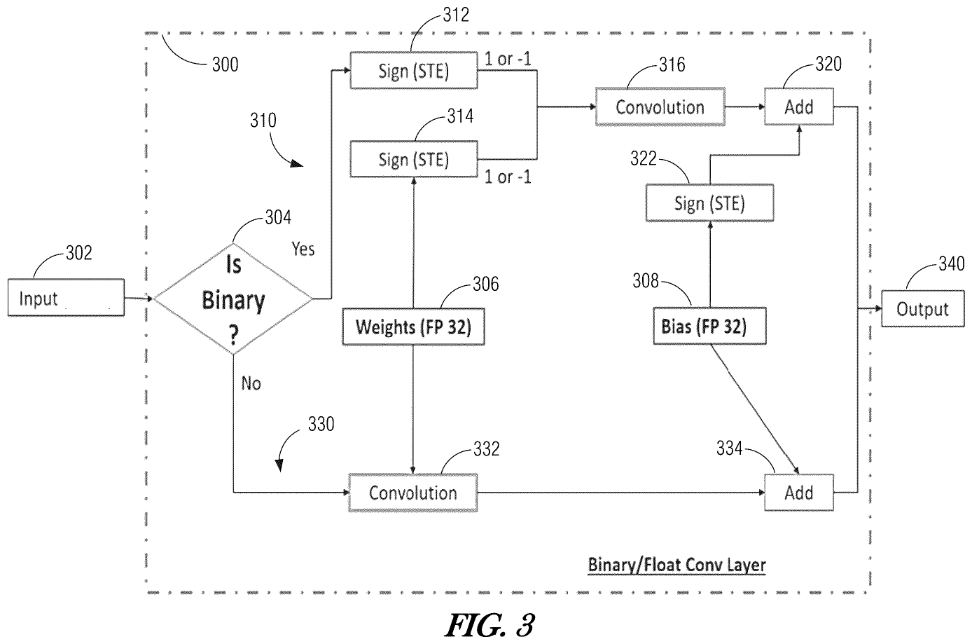

FIG. 3 is a block diagram illustrating an example of an augmented switched-path convolution layer 300 according to an embodiment. Input 302 may be in either of two types of data formats: floating-point, or n-bit binary. Augmented switched-path convolution layer 300 accommodates both data types. Accordingly, mode selector 304 is provided to perform the switching function of directing input 302 along binary-data path 310, or floating-point-data path 330.

Mode selector 304 may determine the type of data format of input 302 based on the data itself, i.e., 32-bit single-precision floating-point, vs. 8-bit binary (encoded in a particular way, e.g., in the exponent field according to IEEE 754, with all 1's in the sign and mantissa fields). Alternatively, mode selector 304 may determine the type of data format according to an externally-supplied indicator, or according to the operational context (e.g., training mode, mth stage). Augmented switched-path convolution layer 300 includes binary convolution engine 316 in binary-data path 310 and floating-point convolution engine 332 in floating-point-data path 330. Each convolution operation shares weights 306 and bias 308 parameters, which in this example are each maintained in floating-point format.

Binary-data path 310 includes one-bit quantizer block 312 for quantizing input data 302, one-bit binary quantizer block 314 for quantizing weights 306, and one-bit binary quantizer block 322 for quantizing bias 308. Each one-bit binary quantizer block may implement a sign function, such as STE or STEα as discussed above, or other suitable 1-bit binary quantization algorithm. The quantized input data at the output of one-bit quantizer block 312 and the quantized weights at the output of one-bit binary quantizer block 314 are fed to convolution block 316. The quantized bias value at the output of one-bit binary quantizer block 322 is added by addition block 320 to the output of convolution engine 316 to produce output 340 in binary format.

Floating-point-data path 330 avoids the quantization blocks. It includes floating-point convolution engine 332, which receives input 302 in floating-point format and weights 306 in their native floating-point format. Its output is fed to addition block 334 for adding floating-point biases 308 to produce output 340 in floating-point format.

In related embodiments, other types of augmented downsampling layers may be utilized. Their structure is substantially as described above for augmented switched-path convolution layer 300, except that binary convolution engine 316 and floating-point convolution engine 332 are replaced, respectively with binary computation engines and floating-point computation engines, such as matrix-multiplication engines, in the case of a fully-connected layer.

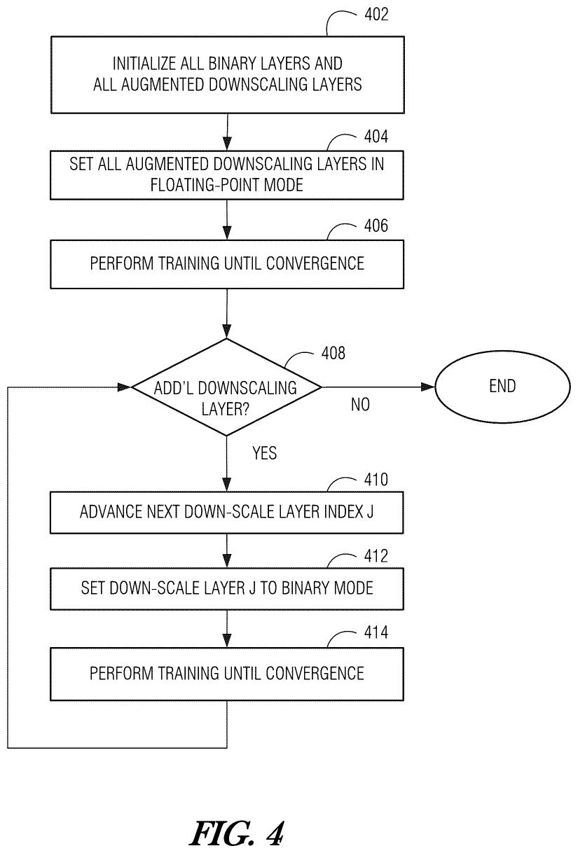

FIG. 4 is a flow diagram illustrating an example process for training a BNN according to some embodiments. The general principle applied in this training process uses augmented downsampling layers sequentially in their floating-point data mode, and then one at a time in binary-data mode. As illustrated, at 402, all layers, including all binary-only layers and all augmented downscaling layers (which are operative in binary or floating-point-data modes), are initialized for training. At 404, all of the augmented downscaling layers are set to operate in their floating-point mode. At 406, the BNN is trained in this mode until convergence is achieved.

In the remaining training operations, the augmented downsampling layers are switched, one at a time, to their binary-data mode, and the BNN is trained. Decision 408 determines if there is an additional downscaling layer to be switched to its binary-data mode. In the affirmative case, the process advances to 410, which identifies the next downscaling layer to be switched. In this example, an index j is used to keep track of which downscaling layer is next to be switched. At 412, the downscaling layer corresponding to the current index J value is set to its binary-data mode. At 414, the network is trained until convergence is achieved. The process loops back to decision 408 to check if there is an additional downscaling layer available to be switched into its binary-data mode. In the negative case, the process concludes.

A related aspect of the invention is directed to 8-bit quantization of the first layer, i.e., input layer 102. The input layer in a BNN serves as the gateway between the floating-point input data and the binary processing domain of the BNN. It ensures that the data to be fed to the subsequent layers is in a form that can be effectively processed by the binary layers that follow, setting the stage for the efficient and specialized computations that the BNNs is designed to perform. One key aspect of the input layer is to balance the need for binary efficiency with the preservation of as much relevant information as possible. This is important because once the data is binarized in the subsequent layers, some precision is inevitably lost. Conventionally, the first layer is kept in floating point to avoid loss of precision.

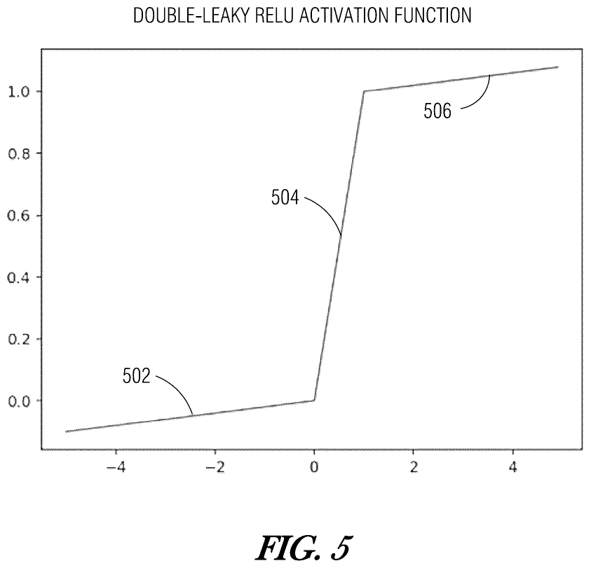

As a departure from the conventional approach, according to some embodiments, the first layer is quantized into 8-bit binary representation. In one approach, a symmetric activation function which limits the output to the range of [−1, 1] is utilized. FIG. 5 illustrates an example of one such activation function which is employed. As depicted, a double-leaky ReLU activation function (ReLUDL) has a first portion 502 for input values below 0, a second portion 504 for input values between 0 and 1, and a third portion 506 for input values of greater than 1. First and third portions 502, 506 have a relatively small slope (e.g., m=0.02), whereas second portion 504 has a relatively steep slope (e.g., m=1). This example may be expressed as:

$$〚 ReLU 〛 \_DL ( x ) = \{ ▮ ( 0.02 x , \& x < 0 @ x , 0 \leq \& x < 1 @ 0.02 x , \& x \geq 1 ) ⊣$$

The ReLUDL activation function suppresses, but does not completely clip, the input values below 0 and greater than 1.

During training, weights determined for the first layer may be quite large in some cases, resulting in the first layer's output occasionally falling outside of the range [−1, 1]. Representing such values using 8-bit binary representation may use multiple bits for the integer portion, thereby taking bits away from representing the fractional part, hence losing accuracy in the representation of the fractional part. One type of solution to this challenge, according to some embodiments, is to apply a constraint to the value of the weights, which prevents their drifting to high values outside of the range [−1, 1].

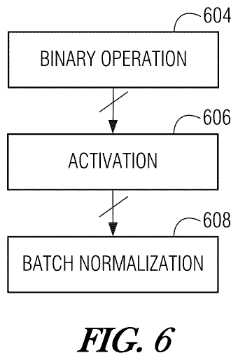

In a related embodiment, a batch-normalization operation is performed after, rather than prior to, activation. FIG. 6 illustrates an example structure of a portion of a BNN layer stack. Binary operation 604, which may be a dense layer, is followed by activation layer 606, such as the ReLUDL activation function. Batch normalization layer 608 follows the activation functional layer. This approach addresses the potential for the weights being adjusted during the process of fusing the binary operation and activation layers for optimization of the BNN, resulting in the weights becoming excessive.

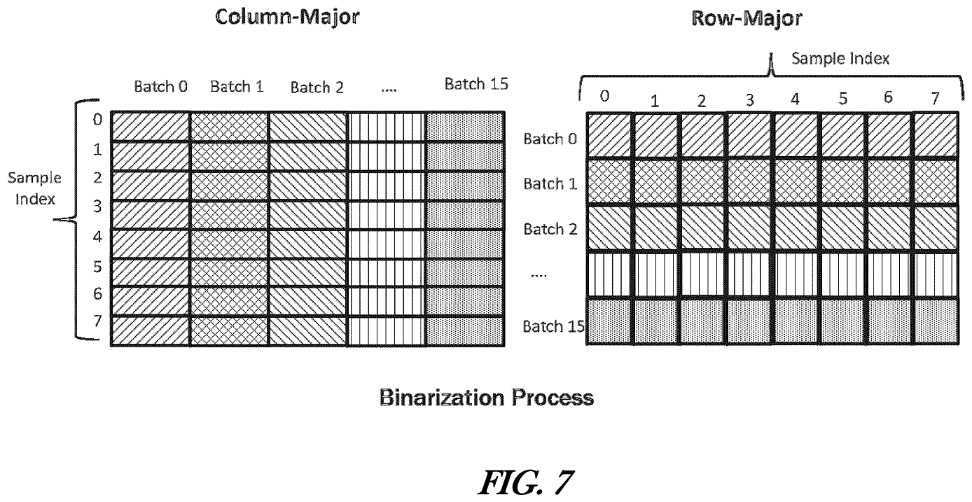

Another aspect of this disclosure is directed to data-structuring techniques to improve computational efficiency in the implementation of a BNN. One approach, which is applicable for SIMD processing, stores data in column-major order to advantageously utilize locality and weights reuse. FIG. 7 illustrates column-major format, compared against row-major format, for a batch size of 16.

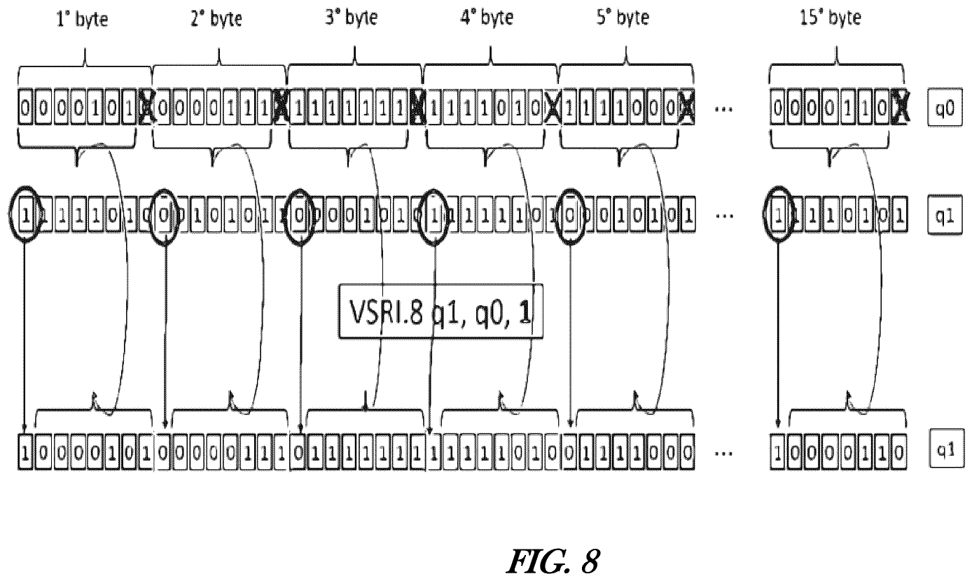

A binarization process according to a related aspect of this disclosure is illustrated in FIGS. 8-12. The goal of this binarization is to extract the sign bit to be used later in ex-nor and popcount logic. With data stored in the column-major order, a SIMD processor can take advantage of the instruction vector shift right and insert (VSRI), available in the ARM NEON instruction set. This allows concatenation of n bits of register A with 8-n bits of register B. FIG. 8 illustrates an example where two NEON registers (q0, q1) are concatenated using VSRI, for 8-bit data type, according to an example.

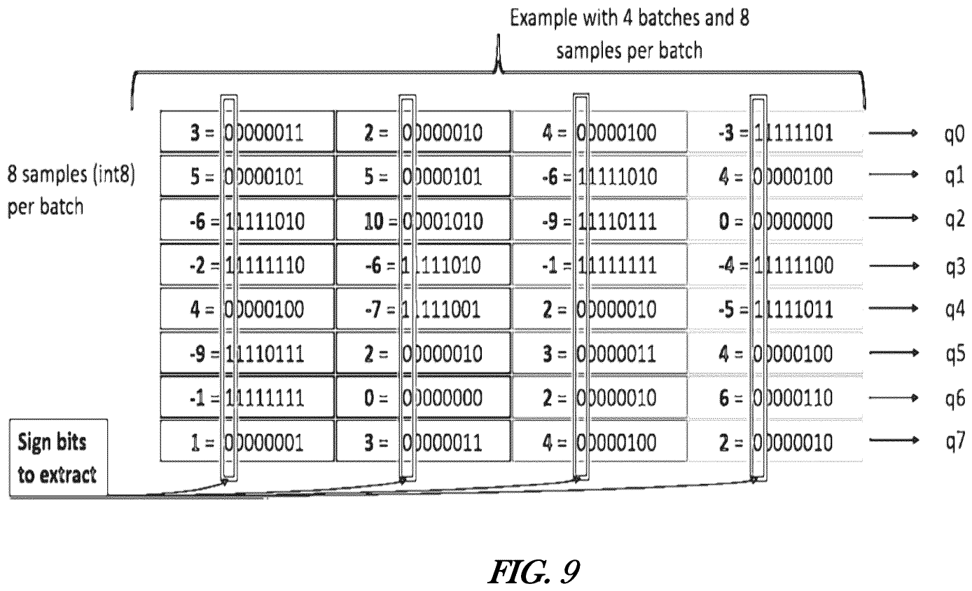

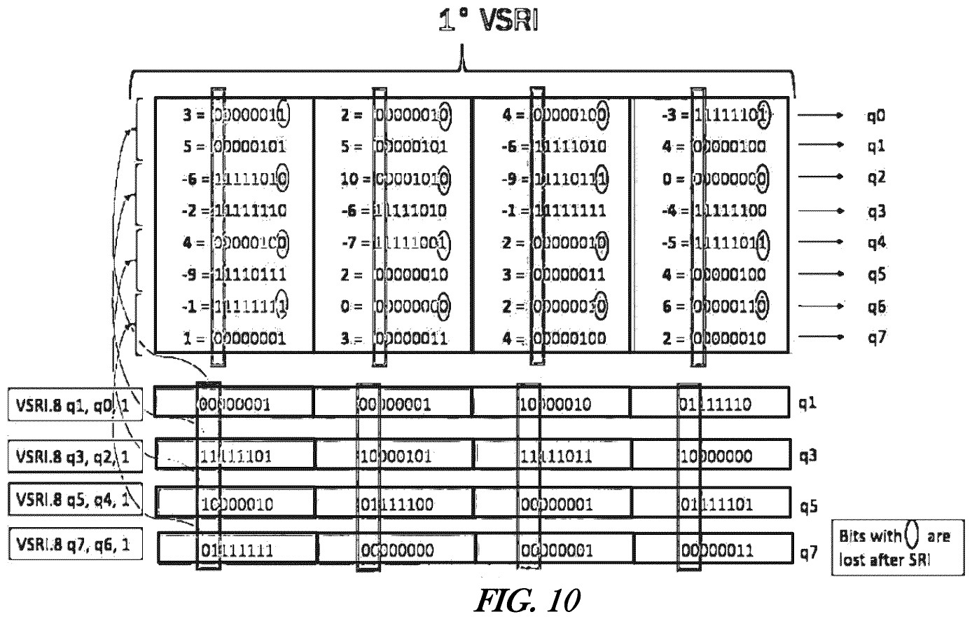

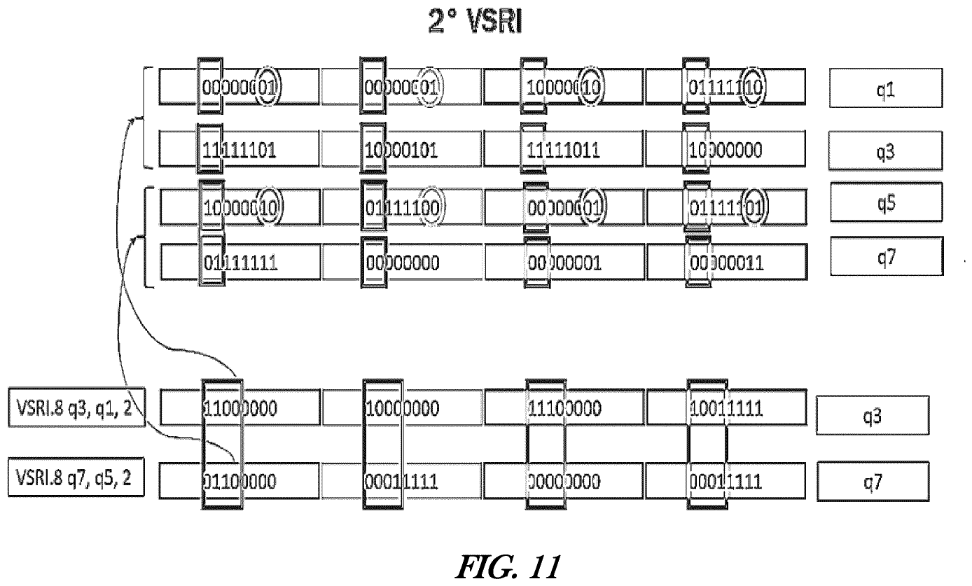

FIG. 9 illustrates the complete binarization process that employs the VSRI (batch size 4) instruction according to an example. The procedure extracts the sign bit of the two registers. Next, as illustrated in FIGS. 10-11, a pair of sign bits is selected and grouped with another pair obtaining four joint sign bits.

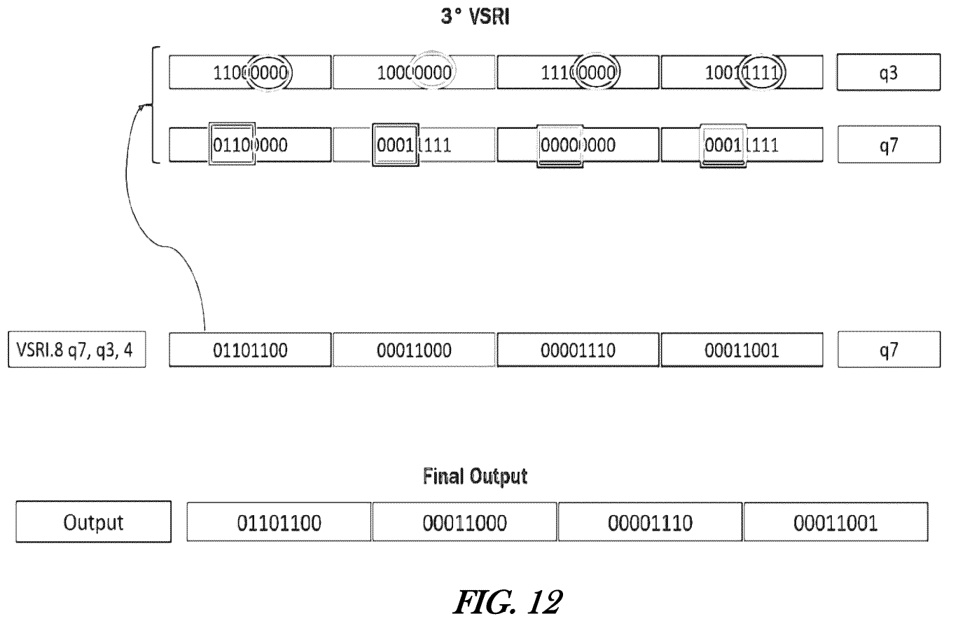

This selecting and grouping process is repeated but in this case two couples, each one having four bits, are fused together to obtain a register where each 8-bit data item contains eight different sign bits, as illustrated in FIG. 12. If a batch size of 16 values is computed, the binarization process employs only 7 VSRI instructions to extract the sign bit from 16*8 input samples. This approach is more computationally efficient than a binarization process of 8-bit input data organized in a row-major order, which would require 12 NEON instructions, some of them more time consuming than VSRI, essentially doubling the binarization time.

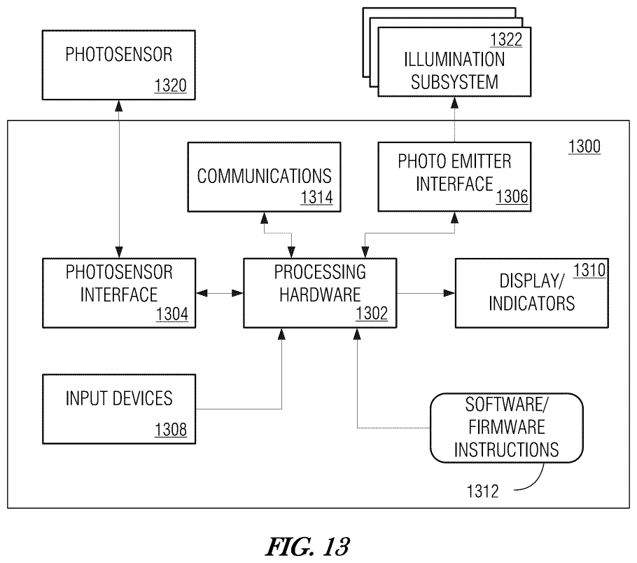

FIG. 13 is a high-level block diagram illustrating an example system architecture of an edge device 1300 in which a BNN according to various embodiments as described above may be implemented. In this example, edge device 1300 is an optical sensing system, such as a symbol reader, object detector, or the like. Edge device 1300 includes processing hardware 1302 operatively coupled to photosensor interface 1304, input devices 1308, display or indicators 1310, communications circuitry 1314, and photo emitter interface 1306. Processing hardware 1302 includes one or more processor circuits that execute software or firmware instructions 1312, with the latter being stored in a non-transitory machine-readable medium such as a read-only memory, flash memory, random-access memory, or the like. Processing hardware 1302, executing software or firmware instructions 1312, may implement first instance of a BNN model according to any of the embodiments described above, such as BNN 100.

The implemented first instance of the BNN uses parameters, such as weights, biases, variable binarization threshold, and the like, which are preconfigured during training of the BNN model. The training may be performed on a different, second instance of the same BNN model, on a remote computing system, using a set of training data. Suitable techniques of training a neural network, such as backpropagation to achieve minimization of a loss function, may be applied. Training adjusts the values of the parameters to achieve convergence. Once the training is complete, the parameter values are extracted, and supplied to configure the first instance.

Edge device 1300 includes various engines, each of which is configured to carry out a function or set of functions, as detailed below. The term “engine” as used herein means a tangible device, component, or arrangement of components implemented using hardware, such as by an application specific integrated circuit (ASIC) or field-programmable gate array (FPGA), Complex Programmable Logic Device (CPLD), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is specifically configured (e.g., hardwired), or temporarily configured (e.g., programmed) to operate in a specified manner or to perform part or all of any operations described herein in connection with that engine.

In examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

The BNN according to embodiments described herein may be implemented using one or more engines. For instance, each class of operation, such as binarized convolution, or matrix multiplication, may be implemented as its own engine. Floating-point downscaling operations may each be implemented as separate engines. In other implementations, each layer type, which may contain a combination of multiple types of operations, may be implemented as an engine. It will be understood that various computational architectures may offer distinct advantages and trade-offs, and that the invention as claimed is not limited to any specific computational architecture unless a particular computational architecture is expressly called out.

Photosensor interface 1304 includes circuitry facilitating the exchange of data between processing hardware 1302 and photosensor 1320. In some examples, photosensor interface 1304 includes data buffers, video decoders, video encoders, address and data bus interfaces, serial data receiver/transmitter circuitry, analog-to-digital (A/D) converter circuitry, and the like. The data communications portions of photosensor interface 1304 may facilitate wired or wireless communication. Photosensor interface 1304 is operative to pass its output (e.g., activated pixels, images, video frames) from their original format as output by photosensor 1320 to processing hardware 1302 in a suitable data format to be read by processing hardware 1302. Photo emitter interface 1306 includes circuitry to control the operation of individual ones, or groups, of the photo emitters of illumination system 106. Photo emitter interface 1306 may include current regulator circuitry, switching circuitry, or the like.

Input devices 1308 include user-operable controls, such as pushbuttons, keypad, touchscreen, and the like, as well as additional sensors, such as a ranging sensor, motion sensor, accelerometer, thermometer, humidity sensor, precipitation sensor, smoke/particulate sensor etc. Display or indicators 1310 include devices such as a liquid-crystal display (LCD), LED indicators, speaker or buzzer, and other suitable output devices.

Communications circuitry 1314 includes wired or wireless communications facilities that provide input and output to and from processing hardware 1302. Communication circuitry may include one or more of the following types of communication circuits: universal serial bus (USB), CAN, I2C, SPI, UART, 112C, Ethernet, personal-area network such as Bluetooth according to an IEEE 802.15 standard, Wi-Fi according to an IEEE 802.11 standard, or the like.

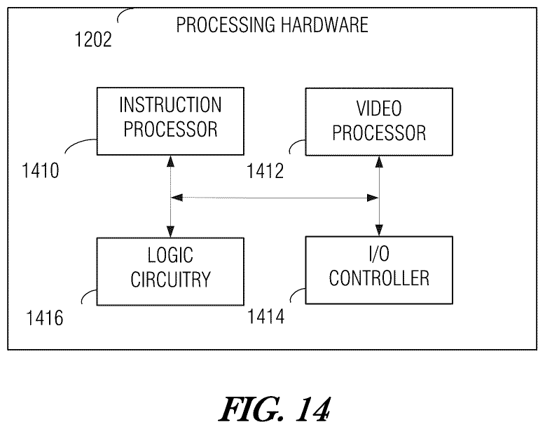

FIG. 14 is a simplified block diagram illustrating a portion of processing hardware 1302 of edge device 1300 according to one example. Processing hardware 1302 includes instruction processor 1410, video processor 1412, and input/output (I/O) controller 1414. Instruction processor 1410 is constructed to execute software or firmware instructions 1312, the execution of which causes instruction processor 1410 to implement engines to carry out the overall functionality of edge device 1300 including implementing a BNN such as BNN 100. In addition, instruction processor 1410 may read input devices 1308 and take actions in response to those inputs; instruction processor 1410 may write output to display or indicators 1310; and instruction processor 1410 may exchange data with communications circuitry 1314 to send and receive data to or from other devices.

Instruction processor 1410 may be of any suitable architecture. As an example, instruction processor 1410 may include a central processing unit (CPU) core, RAM, non-volatile memory, memory controllers, address and data (or shared) busses, serial communications ports such a universal synchronous receiver/transmitter (UART), and peripheral circuitry such as timers, event counters, A/D or D/A converters, pulse-width modulation (PWM) generator, etc.

Video processor 1412 is interfaced with instruction processor 1410, and implements engines to receive captured images from photosensor 1320, and to resample, crop, compress, or combine portions of images, filter, evaluate visual characteristics of the captured images, determine the location of captured visual elements within the image frame, and perform symbol reading or object detection algorithms, where applicable. In some embodiments, video processor 1412 includes a digital signal processor (DSP) core having a computing architecture that is optimized for video processing and including additional or specialized arithmetic logic units (ALUs)-direct-memory access, fixed-point arithmetic, etc., ASIC, FPGA, CPLD, or combination thereof.

I/O controller 1414 includes circuitry that facilitates addressing, data transfer, memory access, and other interactions between instruction processor 1410, video processor 1412, and the other components of edge device 1300. As examples, I/O controller 1414 may include a bus or system interconnect controller, a serial communications hub controller, or the like.

In related embodiments, instruction processor 1410 and video processor 1412 are integrated as a single processing device, such as a digital signal controller (DSC) that is configured to perform the respective functionality of instruction processor 1410 and video processor 1412 described above. Similarly, I/O controller 1414 may also be integrated as part of a DSC implementation. In other related embodiments, some portion of processing hardware 1302 may be implemented with logic circuitry 1416, such as an application-specific integrated circuit (ASIC), FPGA, CPLD, hardware coprocessor, or the like. Logic circuitry 1416 may be utilized to perform certain operations with greater speed or power efficiency than can be conventionally achieved using an instruction processor, such as image filtering, image frame combining, or the like.

### Additional Notes and Examples

Example 1 is a system for implementing a binary neural network (BNN) on a computing device, the system comprising: processing hardware, including instruction processing, memory, and input/output circuitry, the memory including instructions that, when executed by the processing circuitry, cause the processing hardware to implement a first instance of a BNN model that includes: a plurality of layers including an input layer, an output layer, and a plurality of hidden layer groups, each hidden layer group including a downscaling operation layer, a batch normalization layer, and an activation layer; wherein the first instance of the BNN model is operative in an inference mode using preconfigured parameters from a training session performed on a second instance of the BNN model; wherein in the inference mode, each layer of the set of hidden layers receives inter-layer input data and produces inter-layer output data in a forward-propagating direction, wherein the inter-layer input data and the inter-layer output data are represented in n-bit binary format, wherein n is less than 32, and wherein each layer of the set of hidden layers is operative to perform binarized operations on respective input data and at least one of the hidden layers includes, a trained one-bit binary quantizer with a configured binarization threshold; wherein the preconfigured parameters from the training session include weights, biases, and the binarization threshold.

In Example 2, the subject matter of Example 1 includes, wherein the inter-layer input data and the inter-layer output data is in 8-bit binary form.

In Example 3, the subject matter of Examples 1-2 includes, wherein the trained one-bit binary quantizer of the BNN model comprises a straight-through estimator (STE) with configured input offset as the configured binarization threshold.

In Example 4, the subject matter of Example 3 includes, wherein the STE with configured offset is operative in the forward-propagating direction to produce an output of +1 if an input value plus an offset value is greater than zero, and to produce an output of −1 if the input value plus the offset is less than zero.

In Example 5, the subject matter of Example 4 includes, wherein the STE with configured offset is operative in a backward-propagating direction, which is opposite the forward-propagating direction, to produce an output of 1 if an input value is within the range of between −1 plus the offset value, and +1 plus the offset value, and to produce a value of zero if the input value is outside of that range.

In Example 6, the subject matter of Examples 1-5 includes, wherein the downscaling operation layer of each hidden layer group of the BNN model includes: a binary operation engine and a floating-point operation engine, each operative to perform the downscaling operation on respective binary and floating-point input data to the downscaling operation layer; and a switching engine operative to selectively direct the input data to a binary data path within the downscaling operation layer when the downscaling operation layer is configured to operate in a binary-data mode, and to a floating-point data path of the downscaling operation layer when the downscaling operation layer is configured to operate in a floating-point-data mode, wherein the binary data path includes the binary operation engine and wherein the floating-point data path includes the floating-point operation engine.

In Example 7, the subject matter of Example 6 includes, wherein the binary data path of the downscaling operation layer of each hidden layer group further includes a one-bit quantizer operative to quantize the binary input data.

In Example 8, the subject matter of Examples 6-7 includes, wherein the downscaling operation layer maintains weights and bias parameters in floating-point data format, and wherein the weights and bias parameters are converted via respective one-bit quantizers for use by the binary data path.

In Example 9, the subject matter of Examples 6-8 includes, wherein the preconfigured parameters from the training session are determined from the second instance of the BNN model in which the downscaling operation layer of each hidden layer group is first trained when each downscaling operation layer is configured in the floating-point-data mode, and subsequently trained successively for each downscaling operation layer configured in the binary-data mode.

In Example 10, the subject matter of Examples 6-9 includes, wherein the preconfigured parameters from the training session are determined from the second instance of the BNN model in which each activation layer uses a double-leaky rectified linear unit that has a first portion for input values below 0, a second portion for input values between 0 and 1, and a third portion for input values of greater than 1, wherein inputs having values falling in the first and third portions are suppressed relative to inputs falling in the second portion.

In Example 11, the subject matter of Examples 1-10 includes, wherein in the first instance of the BNN model, each batch normalization layer follows the activation layer along the forward-propagating direction.

In Example 12, the subject matter of Examples 1-11 includes, wherein the n-bit binary data is represented in column-major format.

In Example 13, the subject matter of Examples 1-12 includes, wherein the plurality of hidden layer groups includes a downscaling operation layer which is a convolution layer, and a downscaling operation which is a fully-connected layer.

Example 14 is an automated method for implementing a first instance of a binary neural network (BNN) model on a computing device, the method comprising: providing a plurality of layers including an input layer, an output layer, and a plurality of hidden layer groups, each hidden layer group including a downscaling operation layer, a batch normalization layer, and an activation layer; operating the first instance of the BNN model in an inference mode using preconfigured parameters from a training session performed on a second instance of the BNN model; wherein in the inference mode, by each layer of the set of hidden layers: receiving inter-layer input data; producing inter-layer output data in a forward-propagating direction, wherein the inter-layer input data and the inter-layer output data are represented in n-bit binary format, wherein n is less than 32, and performing binarized operations on respective input data; operating, by at least one of the hidden layers, a trained one-bit binary quantizer with a configured binarization threshold; and in the inference mode, applying the preconfigured parameters from the training session which include, weights, biases, and the binarization threshold.

In Example 15, the subject matter of Example 14 includes, wherein the inter-layer input data and the inter-layer output data is represented in 8-bit binary form.

In Example 16, the subject matter of Examples 14-15 includes, operating, by the trained one-bit binary quantizer of the BNN model, a straight-through estimator (STE) with configured input offset as the configured binarization threshold.

In Example 17, the subject matter of Example 16 includes, wherein the STE with configured offset is operative in the forward-propagating direction to produce an output of +1 if an input value plus an offset value is greater than zero, and to produce an output of −1 if the input value plus the offset is less than zero.

In Example 18, the subject matter of Example 17 includes, wherein the STE with configured offset is operative in a backward-propagating direction, which is opposite the forward-propagating direction, to produce an output of 1 if an input value is within the range of between −1 plus the offset value, and +1 plus the offset value, and to produce a value of zero if the input value is outside of that range.

In Example 19, the subject matter of Examples 14-18 includes, wherein applying the preconfigured parameters from the training session includes applying the preconfigured parameters which were generated by the second instance of the BNN model in which the downscaling operation layer of each hidden layer group of the BNN model included: a binary operation and a floating-point operation, each executed during the training session to perform the downscaling operation on respective binary and floating-point input data to the downscaling operation layer; and selectively directing the input data to a binary data path within the downscaling operation layer when the downscaling operation layer was configured in a binary-data mode, directing the input data to a floating-point data path of the downscaling operation layer when the downscaling operation layer was configured to operate in a floating-point-data mode.

In Example 20, the subject matter of Example 19 includes, wherein selectively directing the input data to the binary data path further includes performing one-bit quantization of the binary input data.

In Example 21, the subject matter of Examples 19-20 includes, wherein the preconfigured parameters from the training session are determined from the second instance of the BNN model in which the downscaling operation layer of each hidden layer group is first trained when each downscaling operation layer is configured in the floating-point-data mode, and subsequently trained successively for each downscaling operation layer configured in the binary-data mode.

In Example 22, the subject matter of Examples 19-21 includes, wherein the preconfigured parameters from the training session are determined from the second instance of the BNN model in which each activation layer uses a double-leaky rectified linear unit that has a first portion for input values below 0, a second portion for input values between 0 and 1, and a third portion for input values of greater than 1, wherein inputs having values falling in the first and third portions are suppressed relative to inputs falling in the second portion.

In Example 23, the subject matter of Examples 14-22 includes, wherein in implementing the first instance of the BNN model, each batch normalization layer follows the activation layer along the forward-propagating direction.

Example 24 is at least one machine-readable medium including instructions that, when executed by processing circuitry, cause the processing circuitry to perform operations to implement of any of Examples 14-23.

Example 25 is an apparatus comprising means to implement of any of Examples 14-23.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalents.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A system for implementing a binary neural network (BNN) on a computing device, the system comprising:
processing hardware, including instruction processing, memory, and input/output circuitry, the memory including instructions that, when executed by the processing circuitry, cause the processing hardware to implement a first instance of a BNN model that includes:
a plurality of layers including an input layer, an output layer, and a plurality of hidden layer groups, each hidden layer group including a downscaling operation layer, a batch normalization layer, and an activation layer;
wherein the first instance of the BNN model is operative in an inference mode using preconfigured parameters from a training session performed on a second instance of the BNN model;
wherein in the inference mode, each layer of the set of hidden layers receives inter-layer input data and produces inter-layer output data in a forward-propagating direction, wherein the inter-layer input data and the inter-layer output data are represented in n-bit binary format, wherein n is less than 32, and wherein each layer of the set of hidden layers is operative to perform binarized operations on respective input data and at least one of the hidden layers includes a trained one-bit binary quantizer with a configured binarization threshold; and
wherein the preconfigured parameters from the training session include weights, biases, and the binarization threshold.

2. The system of claim 1, wherein the trained one-bit binary quantizer of the BNN model comprises a straight-through estimator (STE) with configured input offset as the configured binarization threshold.

3. The system of claim 2, wherein the STE with configured offset is operative in the forward-propagating direction to produce an output of +1 if an input value plus an offset value is greater than zero, and to produce an output of −1 if the input value plus the offset is less than zero.

4. The system of claim 3, wherein the STE with configured offset is operative in a backward-propagating direction, which is opposite the forward-propagating direction, to produce an output of 1 if an input value is within the range of between −1 plus the offset value, and +1 plus the offset value, and to produce a value of zero if the input value is outside of that range.

5. The system of claim 1, wherein the downscaling operation layer of each hidden layer group of the BNN model includes:
a binary operation engine and a floating-point operation engine, each operative to perform the downscaling operation on respective binary and floating-point input data to the downscaling operation layer; and
a switching engine operative to selectively direct the input data to a binary data path within the downscaling operation layer when the downscaling operation layer is configured to operate in a binary-data mode, and to a floating-point data path of the downscaling operation layer when the downscaling operation layer is configured to operate in a floating-point-data mode, wherein the binary data path includes the binary operation engine and wherein the floating-point data path includes the floating-point operation engine.

6. The system of claim 5, wherein the binary data path of the downscaling operation layer of each hidden layer group further includes a one-bit quantizer operative to quantize the binary input data.

7. The system of claim 5, wherein the downscaling operation layer maintains weights and bias parameters in floating-point data format, and wherein the weights and bias parameters are converted via respective one-bit quantizers for use by the binary data path.

8. The system of claim 5, wherein the preconfigured parameters from the training session are determined from the second instance of the BNN model in which the downscaling operation layer of each hidden layer group is first trained when each downscaling operation layer is configured in the floating-point-data mode, and subsequently trained successively for each downscaling operation layer configured in the binary-data mode.

9. The system of claim 5, wherein the preconfigured parameters from the training session are determined from the second instance of the BNN model in which each activation layer uses a double-leaky rectified linear unit that has a first portion for input values below 0, a second portion for input values between 0 and 1, and a third portion for input values of greater than 1, wherein inputs having values falling in the first and third portions are suppressed relative to inputs falling in the second portion.

10. The system of claim 1, wherein in the first instance of the BNN model, each batch normalization layer follows the activation layer along the forward-propagating direction.

11. The system of claim 1, wherein the n-bit binary data is represented in column-major format.

12. An automated method for implementing a first instance of a binary neural network (BNN) model on a computing device, the method comprising:
providing a plurality of layers including an input layer, an output layer, and a plurality of hidden layer groups, each hidden layer group including a downscaling operation layer, a batch normalization layer, and an activation layer;
operating the first instance of the BNN model in an inference mode using preconfigured parameters from a training session performed on a second instance of the BNN model;
wherein in the inference mode, by each layer of the set of hidden layers:
receiving inter-layer input data;
producing inter-layer output data in a forward-propagating direction, wherein the inter-layer input data and the inter-layer output data are represented in n-bit binary format, wherein n is less than 32, and
performing binarized operations on respective input data;
operating, by at least one of the hidden layers, a trained one-bit binary quantizer with a configured binarization threshold; and
in the inference mode, applying the preconfigured parameters from the training session which include weights, biases, and the binarization threshold.

13. The method of claim 12, further comprising, operating, by the trained one-bit binary quantizer of the BNN model, a straight-through estimator (STE) with configured input offset as the configured binarization threshold.

14. The method of claim 13, wherein the STE with configured offset is operative in the forward-propagating direction to produce an output of +1 if an input value plus an offset value is greater than zero, and to produce an output of −1 if the input value plus the offset is less than zero.

15. The method of claim 14, wherein the STE with configured offset is operative in a backward-propagating direction, which is opposite the forward-propagating direction, to produce an output of 1 if an input value is within the range of between −1 plus the offset value, and +1 plus the offset value, and to produce a value of zero if the input value is outside of that range.

16. The method of claim 12, wherein applying the preconfigured parameters from the training session includes applying the preconfigured parameters which were generated by the second instance of the BNN model in which the downscaling operation layer of each hidden layer group of the BNN model includes:
a binary operation and a floating-point operation, each executed during the training session to perform the downscaling operation on respective binary and floating-point input data to the downscaling operation layer; and
selectively directing the input data to a binary data path within the downscaling operation layer when the downscaling operation layer was configured in a binary-data mode, directing the input data to a floating-point data path of the downscaling operation layer when the downscaling operation layer was configured to operate in a floating-point-data mode.

17. The method of claim 16, wherein selectively directing the input data to the binary data path further includes performing one-bit quantization of the binary input data.

18. The method of claim 16, wherein the preconfigured parameters from the training session are determined from the second instance of the BNN model in which the downscaling operation layer of each hidden layer group is first trained when each downscaling operation layer is configured in the floating-point-data mode, and subsequently trained successively for each downscaling operation layer configured in the binary-data mode.

19. The method of claim 16, wherein the preconfigured parameters from the training session are determined from the second instance of the BNN model in which each activation layer uses a double-leaky rectified linear unit that has a first portion for input values below 0, a second portion for input values between 0 and 1, and a third portion for input values of greater than 1, wherein inputs having values falling in the first and third portions are suppressed relative to inputs falling in the second portion.

20. The method of claim 12, wherein in implementing the first instance of the BNN model, each batch normalization layer follows the activation layer along the forward-propagating direction.
